(19) United States
(12) Patent Application Publication
(10) Pub. No.: US 2016/0374103 A1
(43) Pub. Date: Dec. 22, 2016

(54) ENHANCED SYSTEM ACQUISITION OF MULTI-RATS IN CELLULAR MODEMS

(71) Applicant: QUALCOMM Incorporated, San Diego, CA (US)

(72) Inventors: Suresh Sanka, Hyderabad (IN); Parthasarathy Krishnamoorthy, San Diego, CA (US); Anand Rajurkar, Hyderabad (IN); Asimava Bera, Hyderabad (IN)

(21) Appl. No.: 14/743,811

(22) Filed: Jun. 18, 2015

(51) Int. Cl. H04W 72/10

(52) U.S. Cl. CPC H04W 72/10; H04W 88/06

(57) ABSTRACT

A method for performing parallel network acquisition attempts on a mobile communication device includes: retrieving mobile communication device information from a look-up table (LUT); identifying, based on the retrieved information, components of the mobile communication device that support one or more radio access technologies (RATs); allocating the components to at least some of the one or more supported RATs; and performing parallel network acquisition attempts for the at least some of the one or more supported RATs using the allocated components.

### BACKGROUND

A multi-subscriber identity module (SIM) mobile communication device may support multiple radio access technologies (RATs), for example, but not limited to, global system for mobile communication (GSM), wideband code division multiple access (WCDMA), long term evolution (LTE), etc. Upon power-up, the mobile communication device acquires each network and RAT sequentially. A delay in system acquisition caused by the sequential acquisition can impact the performance of the acquiring RAT as well as the other RATs supported by the mobile communication device, thereby degrading the over-all mobile communication device performance.

Further, a mobile communication device supporting several technologies and different locations may have different RAT and/or network coverage. During power-up and lost service scenarios, conventional acquisition algorithms perform sequential search of all supported RATs and require a long time to acquire networks. In addition, mobile communication devices that support multi-SIM, multi-RAT, LTE carrier aggregation, etc., require a large set of wideband (WB) and narrowband (NB) capabilities. Conventional sequential algorithms do not use these capabilities efficiently for performing search and system acquisitions.

### SUMMARY

Apparatuses and methods for enhanced system acquisition of multiple RATS in cellular modems are provided.

According to various embodiments there is provided a method for performing parallel network acquisition attempts on a mobile communication device. In some embodiments, the method may include: retrieving mobile communication device information from a look-up table (LUT); identifying, based on the retrieved information, components of the mobile communication device that support one or more radio access technologies (RATs); allocating the components to at least some of the one or more supported RATs; and performing parallel network acquisition attempts for the at least some of the one or more supported RATs using the allocated components.

According to various embodiments there is provided a mobile communication device. In some embodiments, the mobile communication device may include: a plurality of wideband signal processing units, each of the wideband signal processing units configured to input a portion of a baseband signal and output a respective reduced bandwidth signal in a narrower frequency range than the baseband signal determined by the wideband signal processing unit; a plurality of narrowband signal processing units, each of the narrowband signal processing units configured to input at least one of the respective reduced bandwidth signals in the narrower frequency range from one of the wideband signal processing units; and a control unit.

The control unit may be configured to: retrieve mobile communication device information from a look-up table (LUT); identify, based on the retrieved information, the wideband signal processing units and narrowband signal processing units that support one or more radio access technologies (RATs); allocate the wideband signal processing units and narrowband signal processing units to at least some of the one or more supported RATs; and perform parallel network acquisition attempts for the at least some of the one or more supported RATs using the allocated wideband signal processing units and narrowband signal processing units.

According to various embodiments there is provided a non-transitory computer readable medium. In some embodiments, the non-transitory computer readable medium may include instructions for causing one or more processors to perform operations, including: retrieving mobile communication device information from a look-up table (LUT); identifying, based on the retrieved information, components of the mobile communication device that support one or more radio access technologies (RATs); allocating the components to at least some of the one or more supported RATs based on a RAT priority; and performing parallel network acquisition attempts for the at least some of the one or more supported RATs using the allocated components.

According to various embodiments there is provided an apparatus for performing parallel network acquisition attempts for performing parallel network acquisition attempts. In some embodiments, the apparatus may include: means for retrieving mobile communication device information from a look-up table (LUT); means for identifying, based on the retrieved information, components of the mobile communication device that support one or more radio access technologies (RATs); means for allocating the components to at least some of the one or more supported RATs based on a RAT priority; and means for performing parallel network acquisition attempts for the at least some of the one or more supported RATs using the allocated components.

Other features and advantages of the present inventive concept should be apparent from the following description which illustrates by way of example aspects of the present inventive concept.

### BRIEF DESCRIPTION OF THE DRAWINGS

Aspects and features of the present inventive concept will be more apparent by describing example embodiments with reference to the accompanying drawings, in which:

FIG. 1A is a block diagram illustrating a mobile communication device according to various embodiments;

FIG. 1B is a diagram illustrating a network environment for various embodiments;

FIG. 2 is a diagram illustrating a conventional sequential system acquisition process for a mobile communication device;

FIG. 3 is a diagram illustrating a parallel system acquisition process for a mobile communication according to various embodiments;

FIG. 4 is a block diagram illustrating a mobile communication device according to various embodiments; and

FIG. 5 is a diagram illustrating a look-up table according to various embodiments.

FIG. 6 is a flowchart of a method according to various embodiments.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

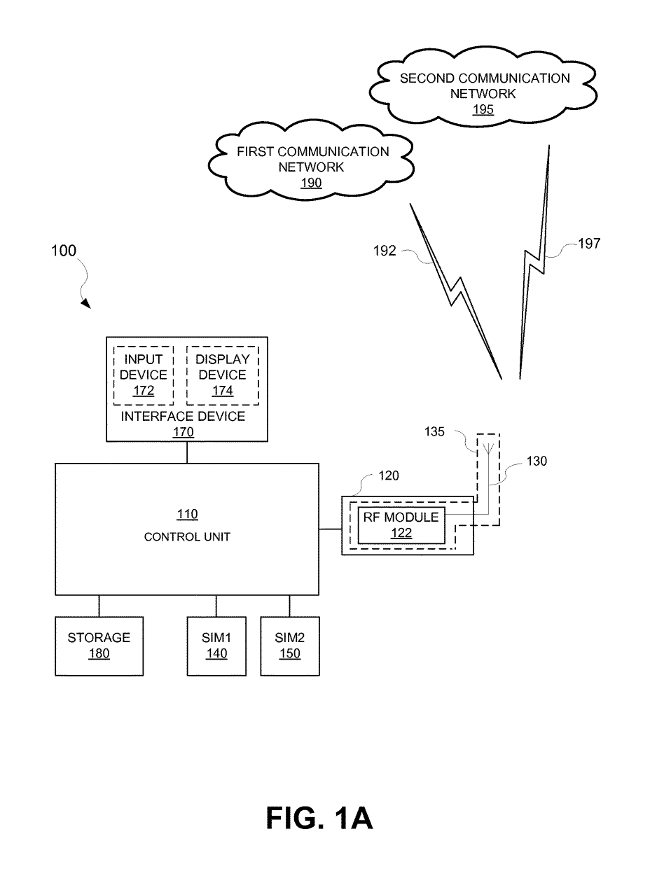

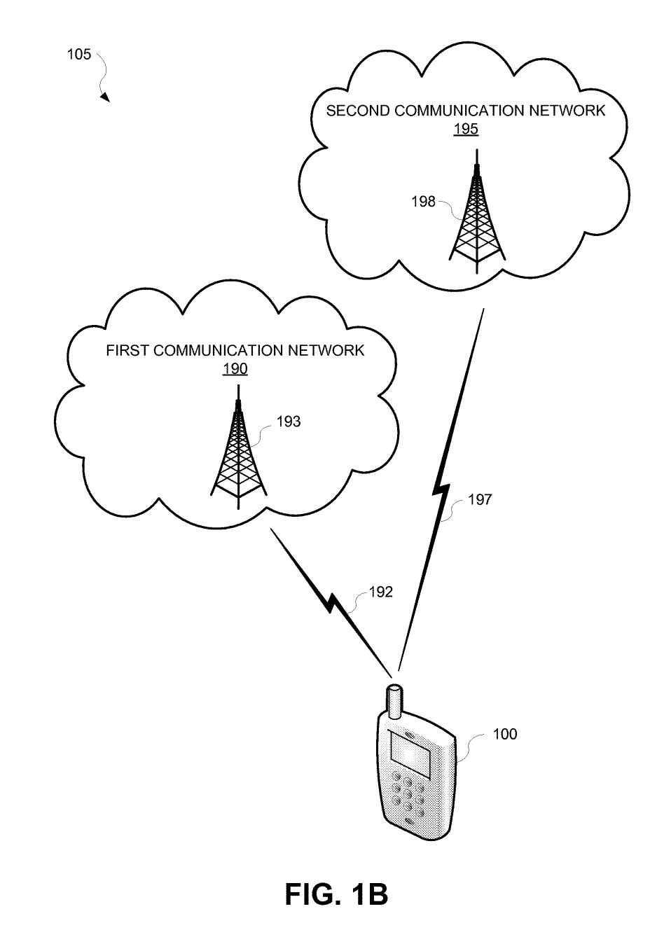

FIG. 1A is a block diagram illustrating a mobile communication device 100 according to various embodiments. As illustrated in FIG. 1A, the mobile communication device 100 may include a control unit 110, a communication unit 120, an antenna 130, a first SIM 140, a second SIM 150, a user interface device 170, and a storage unit 180.

The mobile communication device 100 may be, for example but not limited to, a mobile telephone, smartphone, tablet, computer, etc., capable of communications with one or more wireless networks. One of ordinary skill in the art will appreciate that the mobile communication device 100 may include one or more transceivers (communications units) and may interface with one or more antennas without departing from the scope of the present inventive concept.

The communication unit 120 may include, for example, but not limited to, an RF module 122. The RF module 122 may include, for example, but not limited to a first transceiver (not shown). An RF chain 135 may include, for example, but not limited to the antenna 130 and the RF module 122.

A SIM (for example the first SIM 140 and/or the second SIM 150) in various embodiments may be a Universal Integrated Circuit Card (UICC) that is configured with SIM and/or USIM applications, enabling access to GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. A SIM card may have a CPU, ROM, RAM, EEPROM and I/O circuits. An Integrated Circuit Card Identity (ICCID) SIM serial number may be printed on the SIM card for identification. However, a SIM may be implemented within a portion of memory of the mobile communication device 100, and thus need not be a separate or removable circuit, chip, or card.

A SIM used in various embodiments may store user account information, an IMSI, a set of SIM application toolkit (SAT) commands, and other network provisioning information, as well as provide storage space for phone book database of the user's contacts. As part of the network provisioning information, a SIM may store home identifiers (e.g., a System Identification Number (SID)/Network Identification Number (NID) pair, a Home PLMN (HPLMN) code, etc.) to indicate the SIM card network operator provider.

The first SIM 140 may associate the communication unit 120 with a first subscription (Sub1) 192 on a first communication network 190 and the second SIM 150 may associate the communication unit 120 with a second subscription (Sub2) 197 on a second communication network 195. One of ordinary skill in the art will appreciate that either subscription may be a data and/or voice subscription without departing from the scope of the present inventive concept. Further, one of ordinary skill in the art will appreciate that while various embodiments are described in terms of a dual-SIM dual-standby (DSDS) mobile communication device for convenience, the present inventive concept may be extended to MSMS mobile communication devices.

The first communication network 190 and the second communication network 195 may be operated by the same or different service providers, and/or may support the same or different radio access technologies (RATs), for example, but not limited to, GSM, CDMA, WCDMA, and LTE.

The user interface device 170 may include an input device 172, for example, but not limited to a keyboard, touch panel, or other human interface device, and a display device 174, for example, but not limited to, a liquid crystal display (LCD), light emitting diode (LED) display, or other video display. One of ordinary skill in the art will appreciate that other input and display devices may be used without departing from the scope of the present inventive concept.

The control unit 110 may be configured to control overall operation of the mobile communication device 100 including control of the communication unit 120, the user interface device 170, and the storage unit 180. The control unit 110 may be a programmable device, for example, but not limited to, a microprocessor (e.g., general-purpose processor, baseband modem processor, etc.) or microcontroller.

The storage unit 180 may be configured to store application programs for operation of the mobile communication device 100 that are executed by the control unit 110, as well as application data and user data.

FIG. 1B is a diagram illustrating a network environment 105 for various embodiments. Referring to FIGS. 1A and 1B, a mobile communication device 100 may be configured to communicate with a first communication network 190 on a first subscription 192 and a second communication network 195 on a second subscription 197. One of ordinary skill in the art will appreciate that the mobile communication device may configured to communicate with more than two communication networks and may communicate on more than two subscriptions without departing from the scope of the inventive concept.

The first communication network 190 and the second communication network 195 may implement the same or different radio access technologies (RATs). For example, the first communication network 190 may be a GSM network and the first subscription 192 may be a GSM subscription. The second communication network 195 may also be a GSM network. Alternatively, the second communication network 195 may implement another RAT including, for example, but not limited to, Long Term Evolution (LTE), Wideband Code Division Multiple Access (WCDMA), and Time Division-Synchronous Code Division Multiple Access (TD-SCDMA).

The first communication network 190 may include one or more base transceiver stations (BTSs) including, for example, but not limited to, a first BTS 193. The second communication network 195 may also include one or more BTSs, including, for example, but not limited to, a second BTS 198. A person having ordinary skill in the art can appreciate that the network environment 105 may include any number of communication networks, mobile communication devices, and BTSs without departing from the scope of the present inventive concept.

The mobile communication device 100 may attempt to acquire the first communication network 190 and camp on the first BTS 193. The mobile communication device 100 may also attempt to acquire the second communication network 195 and camp on the second BTS 198. A person having ordinary skill in the art can appreciate that the acquisition of the first communication network 190 performed on the first subscription 192 may be independent of the acquisition of the second communication network 195 performed on the second subscription 197. Furthermore, the mobile communication device 100 may attempt to acquire the first communication network 190 on the first subscription 192 and the second communication network 195 on the second subscription 197.

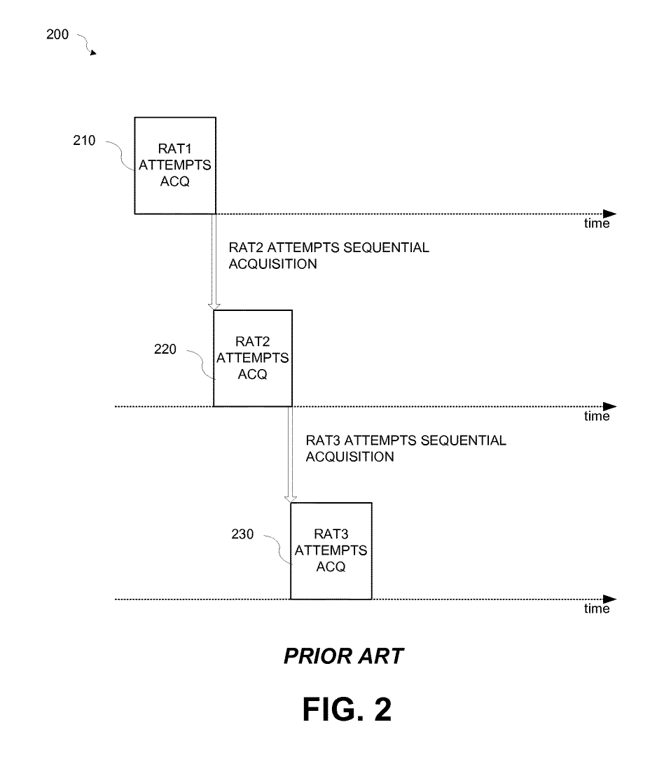

FIG. 2 is a diagram illustrating a sequential system acquisition process 200 for a mobile communication device. Referring to FIG. 2, a first RAT may attempt system acquisition (210). A second RAT may attempt system acquisition (220) only after acquisition by the first RAT is successful or the acquisition attempt by the first RAT times out. Similarly, a third RAT may attempt system acquisition (230) only after acquisition by the second RAT is successful or the acquisition attempt by the second RAT times out. This delay in system acquisition caused by the sequential acquisition may impact the performance of all the RATs supported by the mobile communication device and degrade the over-all mobile communication device performance.

Various embodiments enable parallel system acquisition by multiple RATs during power-up or after loss of service based on hardware capabilities (e.g., the number of RF transceivers, wideband signal processing units, narrowband signal processing units, etc.) of mobile communication device. The hardware capabilities of the mobile communication device may be determined by referring to a look-up table (LUT). The hardware resources that support each RAT may be allocated to the RATs based upon a priority order of RAT acquisition. The mobile communication device may then attempt parallel system acquisition, perform parallel wideband and narrow band processing on multiple RATs, and a select a preferred RAT based upon the priority order of RAT acquisition.

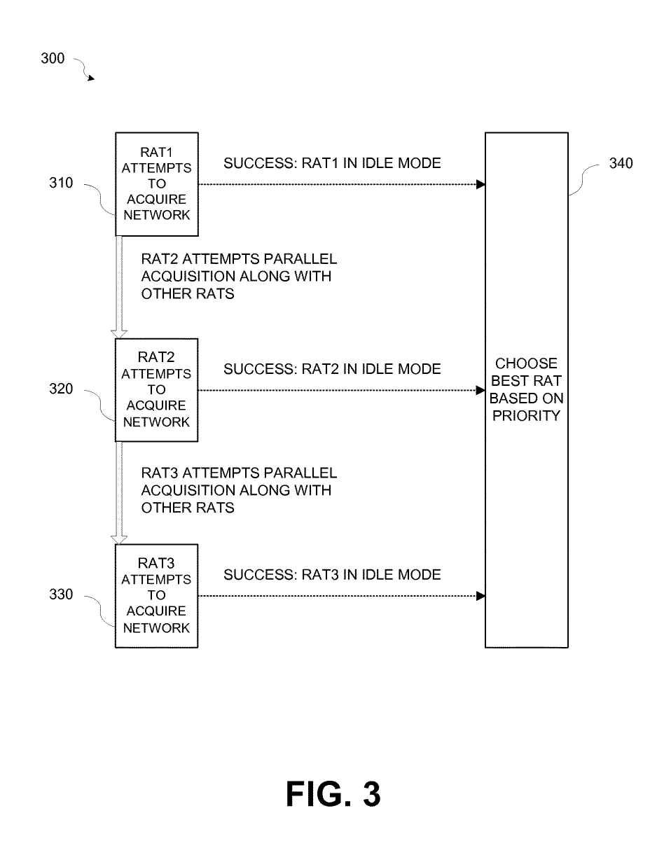

FIG. 3 is a diagram illustrating a parallel system acquisition process 300 for a mobile communication device according to various embodiments. Referring to FIGS. 1A, 1B, and 3, a first RAT may attempt network acquisition (310). A second RAT may attempt network acquisition (320) in parallel with the acquisition attempt by the first RAT. In addition, a third RAT may attempt network acquisition (330) in parallel with the acquisition attempt by the second RAT. When an acquisition attempt is successful, the successful RAT may transition to idle mode.

If an acquisition attempt is unsuccessful for a particular RAT (e.g., the acquisition attempt times out), another acquisition attempt may be made after acquisition attempts by all other supported RATs. If the acquisition attempt is still unsuccessful, acquisition attempts may be repeated, but the process 300 may allow successively longer periods of time to elapse between each unsuccessful acquisition attempt by a particular RAT.

After an acquisition time period, a best RAT among the RATs that successfully acquired a network may be selected based on a priority list (340). For example, the RAT having the highest priority that successfully acquired a network may be selected, and the mobile communication device may camp on the acquired network. The acquisition time period may be on the order of milliseconds and may be a fixed time period or a variable time period based on implementation.

One of ordinary skill in the art will appreciate that the parallel system acquisition process 300 has been described in terms of three RATs for convenience, and that the number of RATs that may attempt system acquisition in parallel may be limited only by the available resources of the mobile communication device and the number of RATs supported by the mobile communication device.

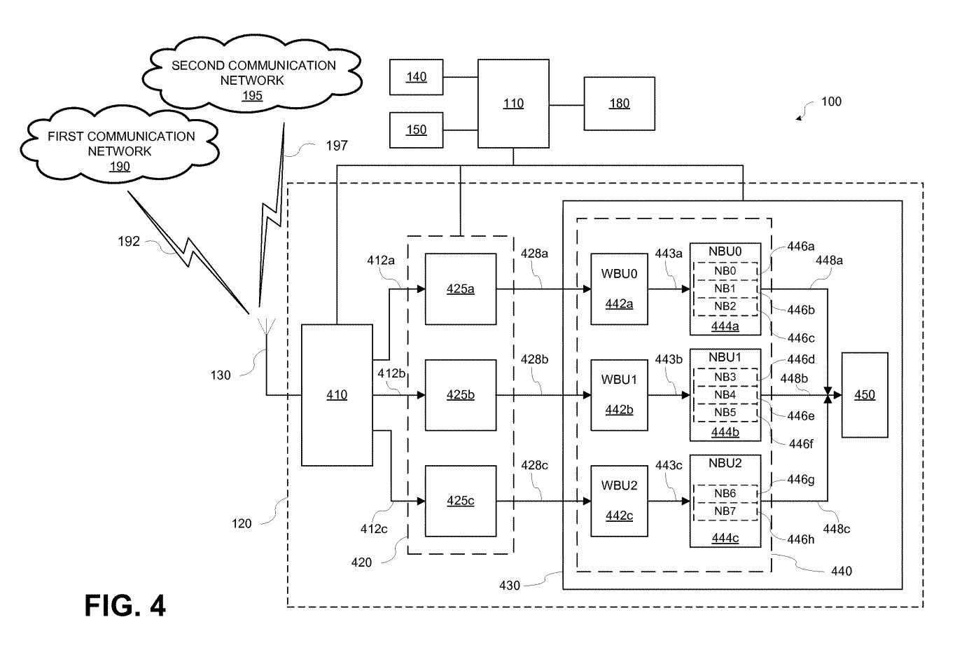

FIG. 4 is a block diagram illustrating signal processing units of a mobile communication device 100 according to various embodiments. Referring to FIGS. 1A, 1B, 3, and 4, the communication unit 120 of the mobile communication device 100 may include a radio frequency (RF) transceiver unit 410, a baseband unit 420, and a processing unit 430. The processing unit 430 may include a resource unit 440 and a demodulating unit 450.

The RF transceiver unit 410 may be configured to receive an RF signal from the antenna 130 and distribute received signals 412a-412c to the baseband unit 420. The baseband unit 420 may include one or more baseband processing units 425a-425c configured to down-convert the signals 412a-412c received from the RF transceiver unit 410. Each baseband processing unit 425a-425c may be configured to output a respective baseband signal 428a-428c in a different frequency range.

The resource unit 440 may include one or more wideband signal processing units (WBU0-WBU2) 442a-442c and one or more narrowband signal processing units (NBU0-NBU2) 444a-444c. Each wideband signal processing unit 442a-442c may be configured to input a portion of the respective baseband signal 428a-428c and output a respective reduced bandwidth signal 443a-443c in a different frequency range. The respective reduced bandwidth signals 443a-443c from the wideband signal processing unit 442a-442c may encompass frequency ranges corresponding to one or more supported RATs. Each wideband signal processing unit 442a-442c may include hardware components, software components, or a combination of hardware and software components.

Each narrowband signal processing unit 444a-444c may be configured to input a respective signal of the respective reduced bandwidth signals 443a-443c from one of the wideband signal processing units 442a-442c and output a respective narrowband output signal 448a-448c in a frequency range of one of a plurality of supported RATs. Each narrowband signal processing unit 444a-444c may be configured to accommodate one or more narrowband modules (NB0-NB7) 446a-446h configured to process signals associated with specific frequency ranges corresponding to the one or more supported RATs.

For example, NBU0 444a may be configured to include NB0-NB2 446a-446c, NBU1 444b may be configured to include NB3-NB5 446d-446f, and NBU2 444c may be configured to include NB6-NB7 446g-446h. One of ordinary skill in the art will appreciate that other configurations of wideband and narrowband signal processing units and narrowband modules may be possible without departing from the scope of present inventive concept.

Each narrowband module 446a-446h may be configured to output a respective narrowband signal of the narrowband signals 448a-448c in one frequency range of one or more frequency ranges specific to one of the plurality of RATs to the demodulation unit 450. Each narrowband module 446a-446h may include hardware components, software components, or a combination of hardware and software components. The wideband signal processing units 442a-442c and the narrowband signal processing units 444a-444c may be configured to perform digital processing of their respective input signals. The demodulation unit 450 may be configured to receive and demodulate the narrowband output signals 448a-448c from the narrowband signal processing units 444a-444c.

One of ordinary skill in the art will appreciate that the number of RF transceivers, wideband signal processing units, narrowband signal processing units, and/or narrowband modules may be more or less without departing from the scope of the present inventive concept.

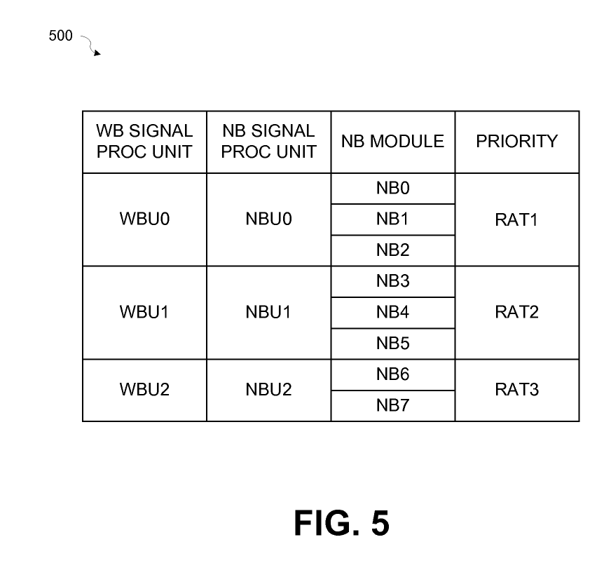

FIG. 5 is a diagram illustrating a look-up table 500 according to various embodiments. Referring to FIGS. 1A, 1B, and 3-5, the look-up table (LUT) 500 may contain information for associating the wideband signal processing units 442a-442c, the narrowband signal processing units 444a-444c, the narrowband modules 446a-446h, and the supported RATs.

The LUT 500 may also contain information about the priority order of the supported RATs. For example, referring to the LUT 500, RAT1 may have the highest priority, followed by the second RAT (RAT2), and then the third RAT (RAT3). Network acquisition may be attempted based on the priority order of the supported RATs. One of ordinary skill in the art will appreciate that these are merely examples and other priority orders may be possible. Various methods known to those of ordinary skill in the art may be used to determine the RAT priority order.

The wideband signal processing units 442a-442c and narrowband signal processing units 444a-444c may be associated with the supported RATs via the LUT 500. For example, using the LUT 500, the mobile communication device 100 may attempt parallel network acquisition by allocating WBU0 442a, NBU0 444a, and NB0-NB2 446a-446c to the first RAT (RAT1); WBU1 442b, NBU1 444b, and NB3-NB5 446d-446f to the second RAT (RAT2); and WBU2 442c, NBU2 444c, and NB6-NB7 446g-446h to the third RAT (RAT3). One of ordinary skill in the art will appreciate that these are merely examples and other combinations may be possible.

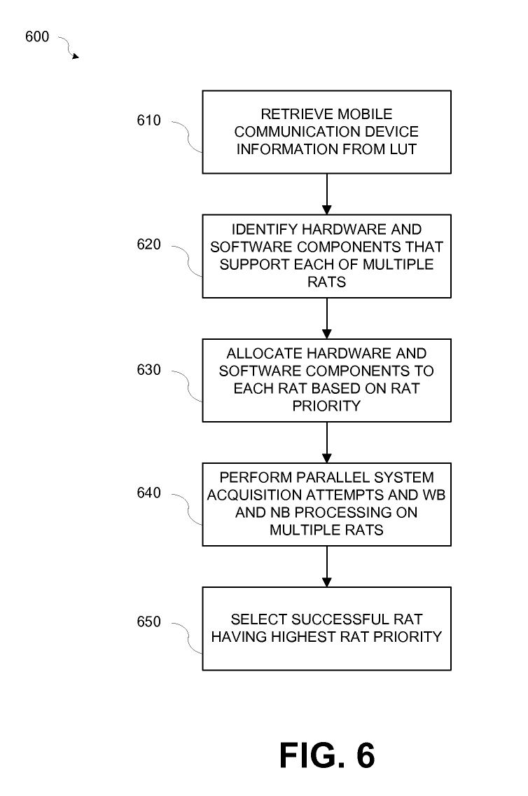

FIG. 6 is a flowchart of a method 600 according to various embodiments. Referring to FIGS. 1A, 1B, and 3-6, the control unit 110 may retrieve information about the (hardware and/or software) capabilities of the mobile communication device 100 from the LUT 500 (610). For example, the control unit 110 may retrieve information about the wideband signal processing units (WBU0-WBU2) 442a-442c, the narrowband signal processing units 444a-444c (NB0-NB7), and the narrowband modules 446a-446h available in the mobile communication device 100. The control unit 110 may also retrieve information about the supported RATs and the RAT priority order.

Based on the information retrieved from the LUT 500, the control unit 110 may identify the available wideband and narrowband (hardware and/or software) components (e.g., WBU0-WBU2 and NB0-NB7) that support each RAT (620). The control unit 110 may allocate the available wideband and narrowband components. In particular embodiments, the control unit 110 may allocate the available wideband and narrowband components based on the RAT priority (630). For example, the control unit 110 may allocate WBU0 442a, NBU0 444a, and NB0-NB2 446a-446c to RAT1; WBU1 442b, NBU1 444b, and NB3-NB5 446d-446f to RAT2; and WBU2 442c, NBU2 444c, and NB6-NB7 446g-446h to RAT3. If the mobile communication device 100 does not include sufficient wideband and narrowband components for all of the supported RATs, the available components may be allocated to the RATs having the highest priority.

The control unit 110 may cause the mobile communication device 100 to perform parallel system acquisition attempts on the multiple RATs (e.g., RAT1-RAT3) while performing the parallel wideband and narrowband processing (640). For example, each wideband signal processing unit (WBU0-WBU2) 442a-442c may input a portion of the baseband signal 428a-428c and output a respective reduced bandwidth signal of the reduced bandwidth signals 443a-443c in a narrower frequency range determined by the particular wideband signal processing unit 442a-442c. The narrower frequency range may encompass frequency ranges corresponding to one or more supported RATs.

Each narrowband signal processing unit 444a-444c may input a respective reduced bandwidth signal of the reduced bandwidth signals 443a-443c from one of the wideband signal processing units 442a-442c and output a respective narrowband signal of the narrowband signals 448a-448c in a frequency range of one of the plurality of supported RATs. The respective narrowband output signals 448a-448c of the narrowband signal processing units 444a-444c may be determined by the included narrowband modules 446a-446h. Each narrowband module 446a-446h may output a narrowband signal in one frequency range of one or more frequency ranges specific to one of the plurality of RATs. The wideband signal processing units 442a-442c and the narrowband signal processing units 444a-444c may be configured to perform digital processing of their respective input signals.

After an acquisition time period, a best RAT among the RATs that successfully acquired a network may be selected based on the RAT priority (650). For example, referring to the LUT 500, if RAT2 and RAT3 each acquire a network but RAT1 fails to acquire a network, the control unit 110 may select RAT2 as the highest priority RAT that successfully acquired a network. The control unit 110 may cause the mobile communication device to camp on the network associated with RAT2.

The method 600 described with respect to FIG. 6 may be embodied on a non-transitory computer readable medium, for example, but not limited to, the storage unit 180 or other non-transitory computer readable medium known to those of skill in the art, having stored therein a program including computer executable instructions for making a processor, computer, or other programmable device execute the operations of the methods.

The accompanying claims and their equivalents are intended to cover such forms or modifications as would fall within the scope and spirit of the protection. For example, the example apparatuses, methods, and systems disclosed herein can be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc., are not intended to limit the order of the steps; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

1. A method for performing parallel network acquisition attempts on a mobile communication device, comprising:
retrieving mobile communication device information from a look-up table (LUT);
identifying, based on the retrieved information, components of the mobile communication device that support one or more radio access technologies (RATs);
allocating the components to at least some of the one or more supported RATs; and
performing parallel network acquisition attempts for the at least some of the one or more supported RATs using the allocated components.

2. The method of claim 1, wherein the retrieving mobile communication device information comprises retrieving information about one or more of wideband signal processing units, narrowband signal processing units, narrowband modules available in the mobile communication device, or combinations thereof.

3. The method of claim 1, wherein the allocating the components comprises allocating the components based on a RAT priority.

4. The method of claim 3, wherein the RAT priority and component allocation are defined in the LUT.

5. The method of claim 1, wherein the performing parallel network acquisition attempts comprises performing parallel wideband processing and narrowband processing of the at least some of the one or more supported RATs.

6. The method of claim 5, wherein the wideband processing comprises inputting a portion of a baseband signal and outputting a reduced bandwidth signal having a narrower frequency range than the baseband signal,
wherein the narrower frequency range encompasses frequency ranges corresponding to at least some of the one or more supported RATs.

7. The method of claim 6, wherein the narrowband processing comprises inputting the reduced bandwidth signal having the narrower frequency range and outputting a narrowband signal in a frequency range of at least one of the one or more supported RATs.

8. The method of claim 1, further comprising selecting a highest priority RAT of the one or more supported RATs that successfully acquired a network during the parallel network acquisition attempts.

9. The method of claim 8, further comprising camping on the successfully acquired a network of the highest priority RAT.

10. The method of claim 1, further comprising waiting successively longer periods of time after each unsuccessful network acquisition attempt by a supported RAT before reattempting one or more network acquisition attempts.

11. The method of claim 1, wherein performing parallel network acquisition attempts comprises attempting network acquisition by the at least some of the one or more supported RATs at a same time.

12. The method of claim 1, wherein network acquisition attempts by a subsequent RAT of the one or more supported RATs may begin before successful network acquisition or failed acquisition attempt by a previous RAT of the one or more supported RATs based on the components that support the subsequent RAT.

13. A mobile communication device, comprising:
a plurality of components that support one or more radio access technologies (RATs); and
a control unit configured to:
retrieve mobile communication device information from a look-up table (LUT);
identify, based on the retrieved information, the components that support one or more radio access technologies (RATs);
allocate the components to at least some of the one or more supported RATs; and
perform parallel network acquisition attempts for the at least some of the one or more supported RATs using the allocated components.

14. The mobile communication device of claim 13, wherein the retrieving mobile communication device information comprises retrieving information about one or more wideband signal processing units, narrowband signal processing units, narrowband modules, or combinations thereof.

15. The mobile communication device of claim 13, wherein the performing parallel network acquisition attempts comprises performing parallel wideband processing and narrowband processing of the at least some of the one or more supported RATs.

16. The mobile communication device of claim 15, wherein the wideband processing comprises inputting a portion of a baseband signal and outputting a reduced bandwidth signal having a narrower frequency range than the baseband signal.

17. The mobile communication device of claim 30, wherein each of the narrowband signal processing units is configured to output a narrowband signal in a frequency range of at least one of the one or more supported radio access technologies (RATs).

18. The mobile communication device of claim 30, wherein each of the narrowband signal processing units comprises one or more narrowband modules, and each of the narrowband modules is configured to output a narrowband signal in a frequency range specific to at least one of the one or more supported RATs.

19. The mobile communication device of claim 18, wherein the control unit is configured to allocate the wideband signal processing units, the narrowband signal processing units, and the narrowband modules based on a RAT priority.

20. The mobile communication device of claim 19, wherein the RAT priority and component allocation are defined in a look-up table (LUT).

21. The mobile communication device of claim 13, wherein the control unit is configured to select a highest priority RAT of the one or more supported RATs that successfully acquired a network during the parallel network acquisition attempts.

22. The mobile communication device of claim 21, wherein the control unit is configured to cause the mobile communication device to camp on the successfully acquired a network of the highest priority RAT.

23. The mobile communication device of claim 13, further comprising waiting successively longer periods of time after each unsuccessful network acquisition attempt by a supported RAT before reattempting network acquisition.

24. The mobile communication device of claim 13, wherein performing parallel network acquisition attempts comprises attempting network acquisition by the at least some of the one or more supported RATs at a same time.

25. The mobile communication device of claim 13, wherein network acquisition attempts by a subsequent RAT of the one or more supported RATs may begin before successful network acquisition or failed acquisition attempt by a previous RAT of the one or more supported RATs based on the available components that support the subsequent RAT.

26. A non-transitory computer readable medium having stored thereon instructions for causing one or more processors to perform operations comprising:
retrieving information of a mobile communication device from a look-up table (LUT);
identifying, based on the retrieved information, components of the mobile communication device that support one or more radio access technologies (RATs);
allocating the components to at least some of the one or more supported RATs based on a RAT priority; and
performing parallel network acquisition attempts for the at least some of the one or more supported RATs using the allocated components.

27. The non-transitory computer readable medium having stored therein a program as defined in claim 26, the operations further comprising selecting a highest priority RAT of the one or more supported RATs that successfully acquired a network during the parallel network acquisition attempts.

28. An apparatus for performing parallel network acquisition attempts for performing parallel network acquisition attempts, the apparatus comprising:
means for retrieving mobile communication device information from a look-up table (LUT);
means for identifying, based on the retrieved information, components of the mobile communication device that support one or more radio access technologies (RATs);
means for allocating the components to at least some of the one or more supported RATs based on a RAT priority; and
means for performing parallel network acquisition attempts for the at least some of the one or more supported RATs using the allocated components.

29. The apparatus of claim 28, further comprising:
means for selecting a highest priority RAT of the one or more supported RATs that successfully acquired a network during the parallel network acquisition attempts.

30. The mobile communication device of claim 13, wherein the components of the mobile communication device that support one or more RATs comprise:
a plurality of wideband signal processing units, each wideband signal processing unit configured to input a portion of a baseband signal and output a respective reduced bandwidth signal in a narrower frequency range than the baseband signal determined by the wideband signal processing unit; and
a plurality of narrowband signal processing units, each narrowband signal processing unit configured to input at least one of the respective reduced bandwidth signals in the narrower frequency range from one of the wideband signal processing units.
